(19) United States
(12) Patent Application Publication
(10) Pub. No.: US 2004/0183661 A1
(43) Pub. Date: Sep. 23, 2004

(54) Overhead obstacle detector for vehicles carrying roof top articles

(76) Inventor: Timothy D. Bowman, Salt Lake City, UT (US)

Correspondence Address: Parsons Behle & Latimer, Suite 1800, 201 South Main Street, Salt Lake City, UT, 84111, US

(21) Appl. No.: 10/739,912

(22) Filed: Dec. 18, 2003

Related U.S. Application Data
(60) Provisional application No. 60/434,881, filed on Dec. 18, 2002.

(51) Int. Cl. B60Q 1/00

(52) U.S. Cl. 340/435; 342/70

(57) ABSTRACT

Devices and methods for detecting the presence of and evaluating the approach to obstacles situated in the path of articles attached to the roof of a vehicle and alerting the driver of the vehicle when an impact or collision between the articles and the obstacles is likely to occur. An example device includes an ultrasonic transducer and circuitry to measure the distance to obstacles, an audible warning device, a microprocessor to perform such tasks as controlling the generation of ultrasonic pulses, measuring the echo delay, calculating the risk of collision, and signaling the warning device, and a housing which protects the components of the device and can be quickly and easily attached to and detached from the vehicle.

### CROSS-REFERENCE TO RELATED APPLICATIONS

This application claims the benefit of U.S. Provisional Patent Application Serial No. 60/434,881, filed Dec. 18, 2002, and which is hereby incorporated by reference in its entirety.

### BACKGROUND INFORMATION

Every year, a great number of drivers mount a bicycle, boat, or cargo container on a car top rack, and later drive into a garage or other low clearance area, causing an impact or collision that can damage thousands of dollars of equipment, accessories, rack components, and the roof of the vehicle itself. The devices and methods disclosed herein can be used to detect overhead obstacles as the vehicle approaches them, and can signal the driver to stop when the approach is fast enough or close enough to result in an impact or collision.

### SUMMARY

A device for and method of detecting the presence of and evaluating the approach to obstacles situated in the path of articles attached to the roof of a vehicle and alerting the driver of the vehicle when an impact or collision between the articles and the obstacles is likely to occur. An example device includes an ultrasonic transducer and circuitry to measure the distance to obstacles, an audible warning device, a microprocessor to perform such tasks as controlling the generation of ultrasonic pulses, measuring the echo delay, calculating the risk of collision, and signaling the warning device, and a housing which protects the components of the device and can be quickly and easily attached to and detached from the vehicle.

### BRIEF DESCRIPTION OF THE DRAWINGS

FIG. 1 is a diagram showing a vehicle fitted with an example device approaching a garage.

FIG. 2 is a top view of an example device.

FIG. 3 is a bottom view of an example device.

FIG. 4 is a cutaway view of an example device.

FIG. 5 is a view of an example remote warning component using a radio receiver.

FIG. 6 is a an example block diagram of electronic components of an example device.

FIG. 7 is an example of the ultrasonic transceiver circuit diagram.

FIG. 8 is a flow diagram of an example main microprocessor program.

FIG. 9 is a flow diagram of an example ping subroutine of the program depicted in FIG. 7.

FIG. 10 is a flow diagram of an example risk calculation subroutine of the program depicted in FIG. 7.

FIG. 11 is a flow diagram of an example test subroutine of the program depicted in FIG. 7.

FIG. 12 is a diagram related to FIG. 1 showing the vehicle closer to the garage, and representing the point of echo fall-off.

FIG. 13 is an example plot of echo delay vs. forward travel showing the echo fall-off condition.

### DETAILED DESCRIPTION

The devices and methods disclosed herein provide a new and practical way to prevent damage to articles carried on the roof of a vehicle. Examples of the devices and methods include electronic components for periodically measuring the distance between a point on the vehicle and an obstacle located in the path of travel of articles carried on the roof of the vehicle, an algorithm for evaluating the measurements to determine the risk of a collision between the articles and the obstacle, and a device for warning the driver of the vehicle to stop when the risk exceeds a predetermined value.

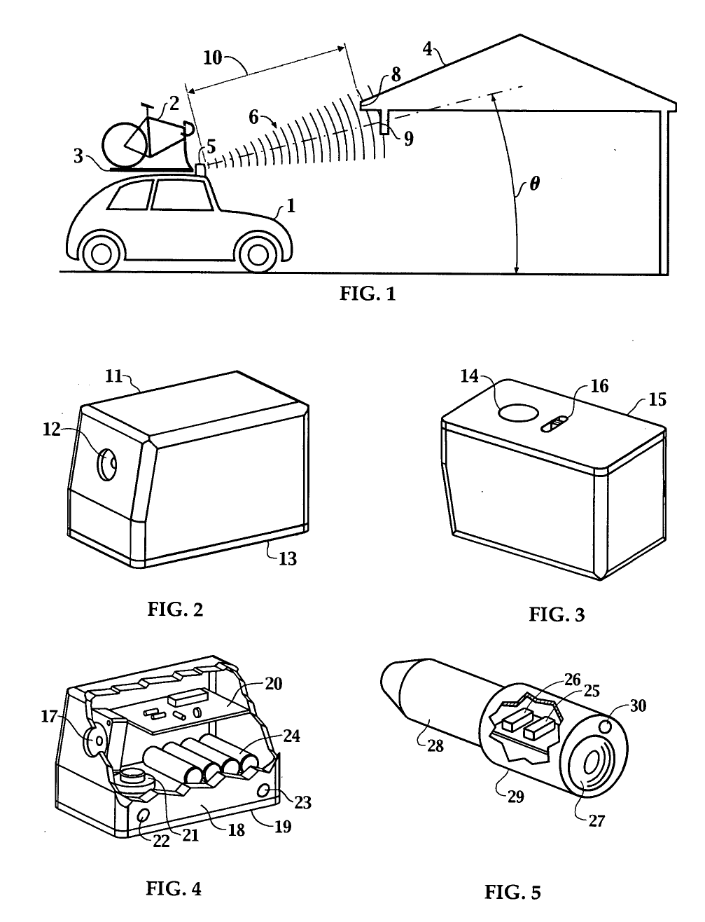

An overview of the operation of the example overhead obstacle detector and methods is shown in FIG. 1. Vehicle 1 carrying bicycle 2 on roof-top rack 3 approaches garage 4 or a similar overhead obstruction. Overhead obstacle detector device 5 is mounted on the forward portion of the roof of vehicle 1, and generates periodic bursts of ultrasonic waves 6 along the path of angle θ, which is substantially in the direction of forward travel of vehicle 1. When vehicle 1 moves sufficiently close to garage 4, ultrasonic waves 6 are reflected by substantially vertical portions 8 and 9 of garage 4 and return to device 5, where they are detected and amplified by an ultrasonic receiver circuit described later. A microprocessor in device 5 measures the elapsed time between transmission and reception of ultrasonic waves 6, and the elapsed time represents the distance 10 between device 5 and reflecting surfaces 8 or 9.

If no echo is received from an obstacle in the path of ultrasonic waves 6, such as when vehicle 1 is driving on the road and has not yet approached garage 4, the microcontroller of device 5 is programmed to go into a low power idle mode for approximately one second before generating the next burst of ultrasonic waves 6. Once an echo return signal from an obstacle is received, and is sufficiently strong to be detected by the receiver circuit, the microprocessor in device 5 begins sending bursts of pulses at a higher rate, for example every 250 ms, and begins calculating the risk of a collision between roof-top articles, represented by bicycle 2, and obstacles, represented by garage 4, using an evaluation technique described later. When the calculated risk exceeds a predetermined level, the microprocessor signals an audible and/or visual alarm contained in device 5, warning the driver of the vehicle to stop immediately.

FIG. 2 shows an example overhead obstacle detector 5 as it may appear when mounted on a vehicle. The measuring and evaluating components may instead be installed in the roof of the vehicle, and the warning component might instead be installed in the driver compartment. The visible features of the device can include housing 11, ultrasonic transducer 12, and magnetic base 13. Magnetic base 13 is sufficiently powerful to hold the device on the roof of the vehicle under the conditions of road speed and wind speed encountered in typical highway driving. The magnetic base allows the driver to rapidly attach the device to the vehicle whenever articles are carried on the roof, and rapidly detach the device when removing the articles or leaving the vehicle unattended.

In an alternate overhead obstacle detector, the magnetic base 13 is removed and replaced instead by one portion of a two piece quick-release clamping mechanism, the second portion of which may be clamped to some portion of the carrier or rack mounted on the roof of the vehicle. Thus the device may still be rapidly attached and detached from the vehicle by separating the two pieces of the quick-release mechanism. This device could be used on vehicles with a non-ferrous roof, and may also include the use of a remote warning device attached to a warning signal connector on housing 11. To accommodate hearing-impaired drivers, an alternate example of the warning device includes a visual warning indicator connected to the external warning connection of the housing, and fixed to the vehicle windshield or mounted inside the driver compartment.

Another example of the overhead obstacle detector is possible where the measuring, evaluating, and warning components are built permanently into the vehicle, and make use of the vehicle's battery for power.

FIG. 3 is a bottom view of an overhead obstacle detector as it may appear when removed from the vehicle and turned over. Speaker 14 can provide the audible warning component of the example device, and has sufficient amplitude to be clearly heard by the driver through the roof of the vehicle and under normal driving conditions. Bottom cover 15 corresponds to magnetic base 13 described above, and may be constructed of magnetic material, or may contain an embedded magnet or magnets, or may be covered by an adhesive-backed magnetic sheet. Switch 16 can turn the device off and on when it is removed and replaced from the vehicle, and may be located in bottom cover 15 to protect it from inadvertent operation. In an alternate example of an overhead obstacle detector, switch 16 is a magnetic switch integrated into bottom cover 15 that is automatically closed when the device is attached to the vehicle roof, and automatically opened when the device is removed.

FIG. 4 shows a cutaway view of overhead obstacle detector 5, and illustrates the internal components. Ultrasonic transducer 17 may be attached to housing 18, and could be sealed to prevent water from entering housing 18. In this example, transducer 17 may be situated at angle 7 in FIG. 1 with respect to the longitudinal axis of housing 18. In an alternate example of the overhead obstacle detector, the attachment method of transducer 17 may allow this angle to be adjusted by the driver when the nominal value of angle 7 is not suitable for typical operating conditions, such as when the vehicle has a roof plane that deviates substantially from horizontal. In another example of an overhead obstacle detector, adjustment of angle 7 could be accomplished with a mechanism for changing the angle of bottom cover 19 with respect to housing 18, for example a wedge-shaped shim.

In the example overhead obstacle detector, circuit board 20 contains the ultrasonic transmitter and receiver circuitry, microprocessor, and additional supporting electronic components. Transducer 17, speaker 21, external alarm connector 22, external power connector 23, and batteries 24 are connected to circuit board 20.

An alternate example of the warning component is shown in FIG. 5, and consists of a radio receiver 25, microprocessor 26, a warning speaker or buzzer 27, and an accessory adapter plug 28, or alternately a battery. This example of the warning component may be fitted inside the vehicle driver compartment, and receives signals from a low-power radio transmitter embedded on circuit board 20. In this example, a signal could be transmitted from device 11 to warning component 29 when the alarm condition is met, and the warning speaker or buzzer 27 could be activated. The warning component may alternately include one or more LEDs or other visual status indicators 30 to signal the driver if the device 11 is not operating properly, for example when the battery is low, or the device 11 is not turned on, or the radio transmitter or receiver is not working. To provide status information about operating conditions, device 11 could transmit a periodic signal to warning component 29, and microprocessor 26 could activate indicator or indicators 30 according to the presence or state of the periodic signal.

In another example overhead obstacle detector, radio receiver 25 may be replaced with an infra-red optical receiver, and a remote infra-red optical transmitter may be attached to external alarm connector 22.

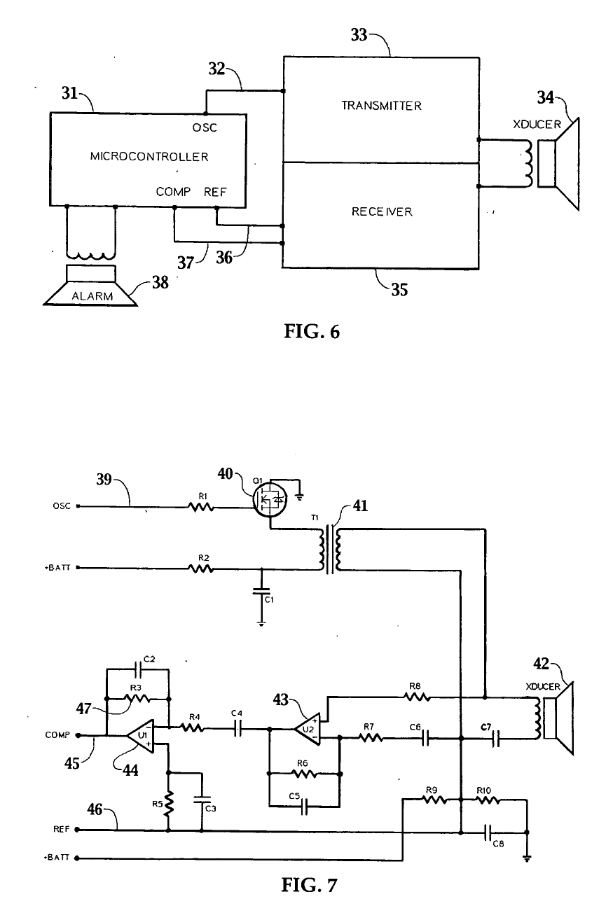

FIG. 6 is a block diagram showing an example of the circuit board, transducer, and speaker. Microcontroller 31 outputs a square wave signal on output line 32, which is amplified by transmitter 33 and sent to the ultrasonic transducer 34. Echo signals received by transducer 34, which is used in this example for both transmitting and receiving, are detected and amplified by receiver 35, which outputs a reference voltage and comparator signal on lines 36 and 37, respectively. Alternate examples of the overhead obstacle detector may include a separate transmitting and receiving transducer. After sending the pulse signal on line 32, microcontroller 31 starts an internal timer, waits for a time period corresponding to the ringing period of the transducer, and then monitors comparator line 37. When the signal voltage on comparator line 37 exceeds the voltage on reference line 36, the value of the internal timer is captured, and a risk evaluation calculation described below is initiated. When the risk exceeds a predetermined maximum value, the microcontroller outputs to speaker 38 a signal corresponding to a collision warning. In alternate examples of the overhead obstacle detector, the microcontroller periodically tests for low battery voltage and/or the presence of dirt or other contaminants on transducer 34 according to procedures described below, and outputs signals corresponding to these conditions on speaker 38.

The ultrasonic transceiver circuit of the example device is show in FIG. 7. The transmit pulse generated by the microcontroller is input on line 39, and controls the gate of enhancement MOSFET 40. This causes current to flow through the primary winding of transformer 41 and generates a high voltage signal driving ultrasonic transducer 42. When an echo is received by transducer 42, it generates a voltage on the input of operational amplifier 43, which amplifies the signal and inputs it to operational amplifier 44. Operational amplifier 44 outputs the comparator voltage which is sent to the microprocessor on line 45. The reference voltage is output on line 46. The detection sensitivity can be adjusted via resistor 47. In an alternate example of the ultrasonic transceiver, the receiver circuit can be replaced by an integrated sonar ranging chip such as the Texas Instruments TL852.

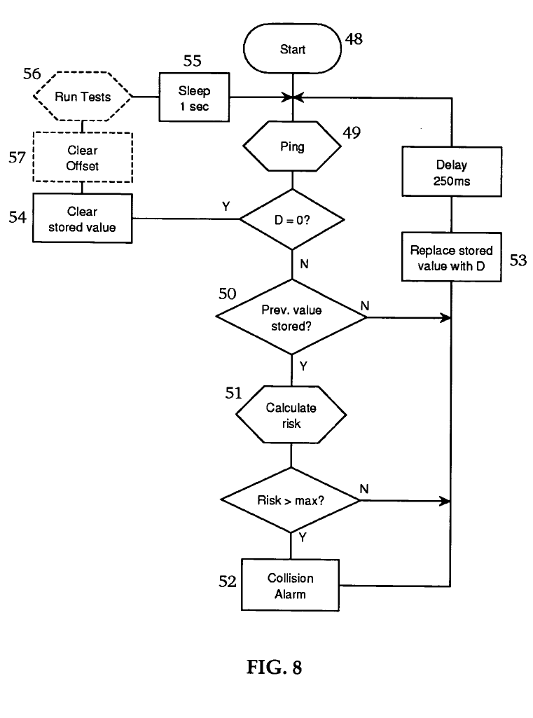

FIG. 8 is a flow diagram of an example of the main program of the microprocessor. Upon startup at 48, such as when the device is switched on or power is connected, the microcontroller can immediately execute the ping subroutine 49, which is described in detail below. Ping subroutine 49 returns a value representing the time delay D between sending and receiving the burst of ultrasonic pulses, and hence the distance to the closest object which returns an echo loud enough to trigger the comparator as described above. If there are no detectable echoes within a predetermined time out period, the ping subroutine returns 0. If a time value is returned, the program proceeds to step 50, which tests for the presence of a stored time value from the previous ping. If a previous time value exists, the program proceeds to the calculation subroutine 51, which is described below. The current and previous time values are used by calculation subroutine 51 to calculate the value of the risk parameter. Next, the program compares the risk parameter returned by the calculation subroutine to a predetermined maximum value. If the risk is greater than the predetermined maximum, the collision alarm routine 52 is called to signal the alarm device and thus warn the driver of a collision. The program then proceeds to 53, where the stored time value is replaced by the current time value. Next, the program waits for an interval representing the desired sample rate between successful pings of approximately 250 ms. If the ping subroutine 49 times out instead of returning a value, the program proceeds to block 54, where the stored time value is cleared. The program then proceeds to 55, where the microprocessor is put to sleep for a period of approximately one second. The processor then wakes up and proceeds again to the ping subroutine 49. In an alternate example, the program may proceed from block 54 to the test subroutine 56, which optionally tests the battery voltage, and/or the condition of the ultrasonic transducer, as described later.

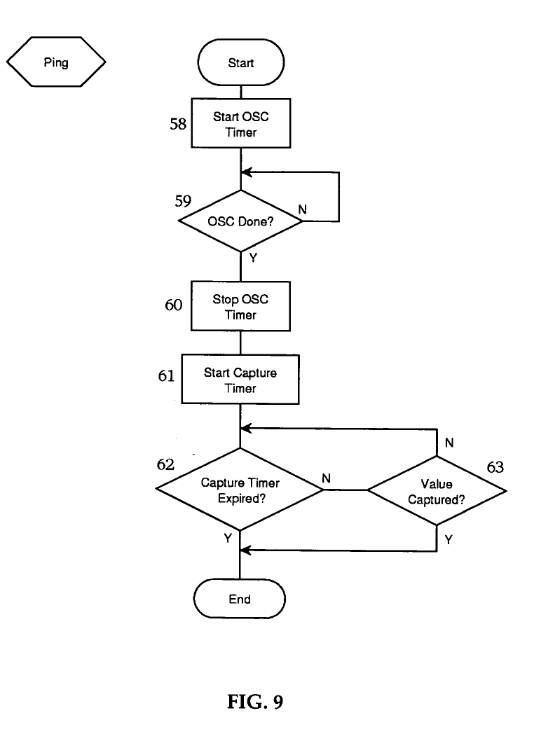

The flow diagram of the ping subroutine is shown in FIG. 9. The program first starts the pulse interval timer in block 58, which begins generating the square wave output for the ultrasonic transmitter as described above. The interrupt routine for the pulse timer increments a counter after each cycle, which is checked in block 59, and when a predetermined number of pulses have been sent, the program proceeds to block 60 and turns off the pulse timer. Next, the comparator capture timer is started in block 61, and the program loops through blocks 62 and 63 waiting for the capture timer to expire, or a value to be captured, whichever comes first. The ping subroutine then ends, and returns either the captured timer value, or zero if the timer expired. The expiration time for the capture timer is at least the echo delay time required for echoes at the maximum range of the ultrasonic detection circuit from a large acoustically reflective surface.

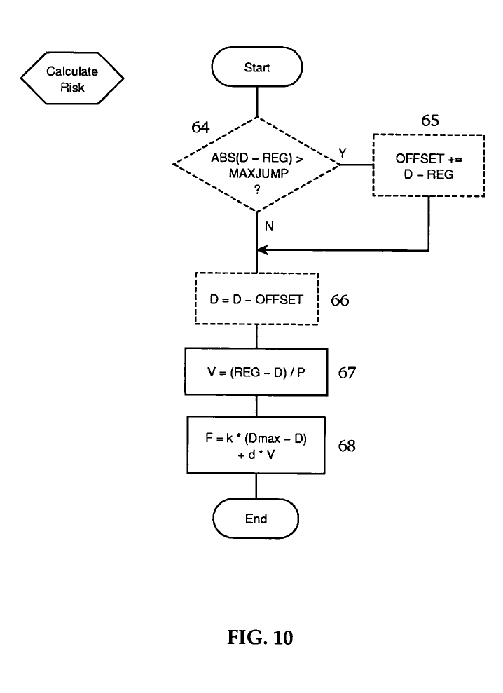

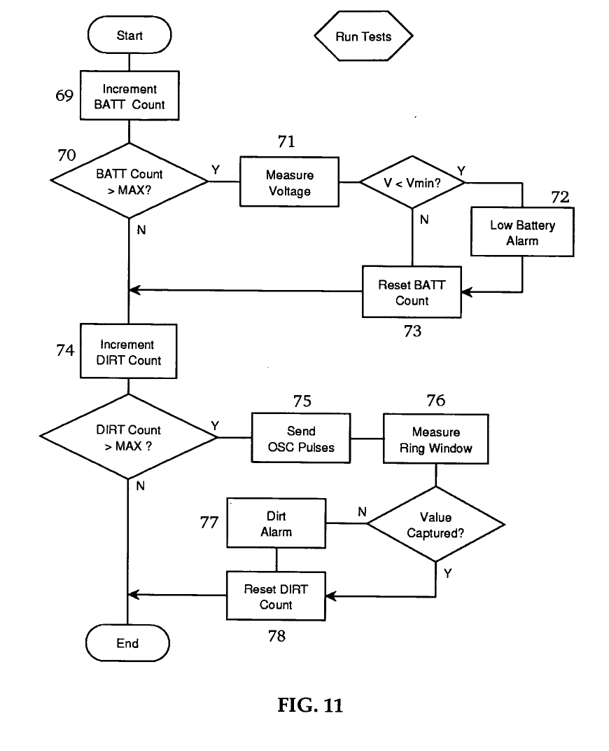

FIG. 10 is a flow diagram of an example of the calculation subroutine, corresponding to the evaluation components of the overhead obstacle detector. The critical condition for signaling the alarm is determined by the control program using the current value of the pulse echo delay returned by the ping routine of FIG. 9 to represent the distance between the obstacle detector and an obstacle, and the current value along with the stored previous value to calculate the relative speed between the detector and the obstacle. To facilitate parameterisation of the distance and speed components, and to provide a single parameter representing the risk of collision, the system may be modeled as a virtual spring and damper connected between the vehicle and the obstacle, where the virtual spring is compressed as the vehicle approaches the obstacle. The risk parameter could thus be the total virtual force F exerted by the spring and damper:

$$F = kx + δ \frac{ⅆ x}{ⅆ t}$$

The virtual spring rate k and damping coefficient δ are determined empirically to provide a reasonable degree of advance warning, and to prevent undesirable false alarms, such as when approaching a slowing vehicle in traffic or stopping behind a truck or in front of a large acoustically reflective surface. The virtual spring compression x can be calculated by subtracting the current echo delay from a value representing the echo delay at the maximum range of the ultrasonic detection circuit. The velocity can be calculated using the difference between the current and previous echo delay values, divided by the elapsed time period between those two values, which in an alternate example of the program may be varied according to the current value of the delay time. Thus the virtual force F is:

$$F = k ( {x}_{max} - x ) + δ ( \frac{x - {x}_{t - 1}}{P} )$$

where F is the virtual force, k is the virtual spring constant, xₘₐₓ is the maximum distance, x is the current distance, δ is the virtual damping coefficient, xₜ₋₁ is the previous sample distance, and P is the time between the current and previous samples. The alarm condition is met when:

F>Fₘₐₓ

where Fₘₐₓ may be determined empirically along with k and δ to correspond to the closest approach distance and highest approach speed that are acceptable under most actual circumstances.

Returning to FIG. 10, program blocks 64, 65, and 66 correspond to an alternate example of the evaluation method, and will be described later. The example calculation subroutine begins at block 67, calculating the velocity of the approach by dividing the difference between the current and last delay times by the sample period. The last delay time is represented in the diagram as REG, the current time by D, the sample period by P, and the velocity by V. In block 68 the program then calculates the virtual force parameter, represented in the diagram by F, using a representation of the force equation above where k represents the spring constant k, Dₘₐₓ the value of xₘₐₓ, and d the damping coefficient δ. The subroutine then exits and returns the virtual force value to the main program.

As discussed previously, some examples of the overhead obstacle detector may test the battery condition and/or transducer contamination. FIG. 11 shows the flow diagram for the test program code. Blocks 69 and 70 increment a counter to determine if it is time to run the battery test, and if so, block 71 is executed and uses the comparator or optionally an additional circuit on the circuit board to test the battery voltage. If the voltage is below a predetermined minimum, the alarm is signaled and the counter is reset in blocks 72 and 73. The test for transducer contamination begins at block 74 incrementing the test counter, and if it is time to run the test executes block 75, which sends a burst of pulses to the transducer. In block 76, a timer is set up to isolate a time window in which to activate the comparator and corresponding to the period in which a clean transducer is still ringing. The comparator is used to measure the transducer voltage during this window, and if the transducer has been damped by dirt or other contaminants, the ringing amplitude will not be sufficient to trip the comparator, and the dirty transducer alarm is sent to the alarm device in block 77. If the transducer is clean, the comparator will be set, and the alarm is not signaled. After clearing the alarm counter in block 78, the subroutine returns.

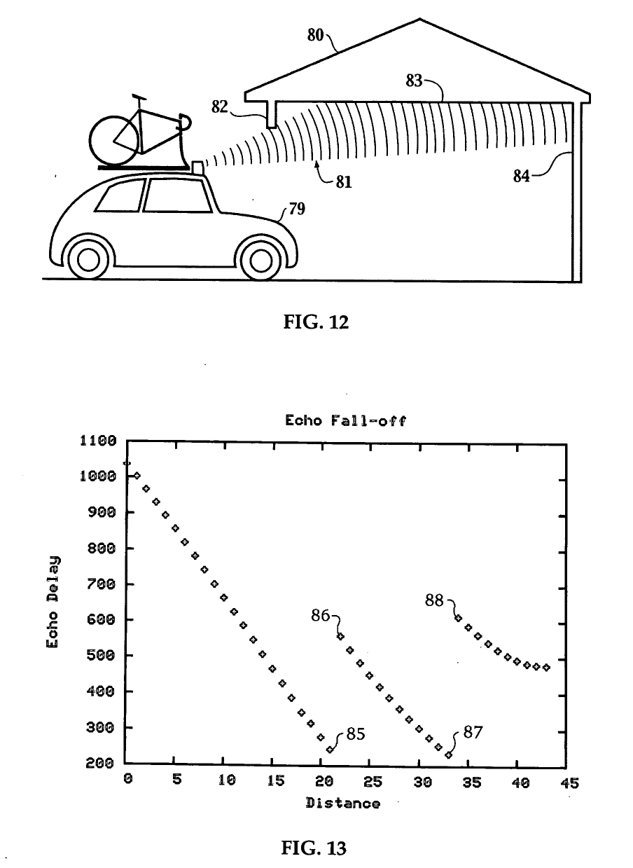

FIG. 12, which is closely related to FIG. 1, shows vehicle 79 closely approaching garage 80, and depicts a condition referred to herein as echo fall-off. In this condition, vehicle 79 has advanced far enough toward or into garage 80 that the ultrasonic beam path 81 is no longer reflected by garage surface 82, and echo signals are now reflected by objects on garage ceiling 83, such as beams or garage door equipment, or reflected by back wall 84 of the garage. In an alternate example of the main and calculating routines of the microcontroller program logic, and in case the control logic of the device has not already signaled an alarm, the sudden increase in echo delay time as the echo signal falls off of surface 82 may be treated by the control logic as an indication that an echo fall-off has occurred, and the difference between the echo delay before and after the fall-off condition may be subtracted from subsequent echo delays. Looking at FIG. 10, program block 64 detects the echo fall-off, using the predetermined value MAXJUMP, and executes the offset adjusting block 65. Block 64 tests for both echo fall-off and the inverse of echo fall-off, which occurs as the vehicle is backing away from the garage. In this way, a reasonably accurate representation of the position of the vehicle is maintained as long as the device is operating continuously during approach and backing maneuvers. The offset value may then subtracted from the current echo time value in block 66, and the subsequent calculation of the virtual force continues with block 66. In addition, the main program block in FIG. 8 contains an additional block 57, to clear the offset value when the vehicle leaves the approach area and the ping subroutine begins timing out.

FIG. 13 is a plot of data obtained with a prototype device as echo fall-off occurs. The horizontal axis represents the forward position of the vehicle as it approaches a garage, and the vertical axis is the echo delay measurement. The jump in echo delay time between points 85 and 86 represents a first echo fall-off condition, and the jump between points 87 and 88 show a second echo fall-off. The alternate example of the control logic described above effectively joins point 85 with point 86, and point 87 with point 88, to form a continuous curve. Thus the risk evaluation method can continue to function progressively as the vehicle moves into the garage.

Having described the components of and examples of the device and methods of this disclosure, it should now be understood that many additional enhancements and modifications can be made to the device or methods which are still within the scope and intent of the disclosure.

I claim:

1. An overhead obstacle detector for detecting the presence of and evaluating the approach to obstacles situated in the path of a vehicle to which the overhead obstacle is attached, the overhead obstacle detector comprising:
an ultrasonic transducer capable of emitting an ultrasonic signal that can ping objects in the path of a vehicle to which the overhead obstacle detector is attached,
a receiver for receiving ultrasonic signals reflected from objects in the path of a vehicle to which the overhead obstacle detector is attached,
circuitry capable of using said reflected signals to calculate the distance between the vehicle to which the overhead obstacle detector is attached and an object in the path of the vehicle,
apparatus for calculating a risk of collision between an obstacle pinged and the vehicle based on the calculated distance said transducer and a detected obstacles and the relative speed between the transducer and a detected obstacle, and
means for signaling the driver of a vehicle to which the overhead obstacle detector is attached that said risk of collision is high.

2. A device as in claim 1 wherein said ultrasonic transducer, said circuitry, said apparatus for calculating a risk of collision and said means for signaling are built into the vehicle and are powered by a battery that is the main vehicle battery.

3. A device as in claim 1 further comprising:
a housing that contains said ultrasonic transducer, said circuitry, said apparatus for calculating a risk of collision.

4. A device as recited in claim 3 further comprising means for mounting said housing to a structure of said vehicle selected from the group consisting of the vehicle roof and the vehicle roof rack.

5. A device as recited in claim 1 wherein said means for signalling is an alarm.

6. A device as recited in claim 3 further comprising a battery contained in said housing for powering the overhead obstacle detector.

7. A device as in claim 1, where said means for signaling includes indicators for indicating the status of said ultrasonic transducer, said circuitry and said apparatus for calculating a risk.

8. A device as recited in claim 7 wherein said indicators are selected from visual and audio indicators.

9. A device as recited in claim 1 wherein said apparatus for calculating a risk is in communication with said means for signalling via wireless radio link.

10. A device as recited in claim 1 wherein said apparatus for calculating a risk is in communication with said means for signalling via infra-red optical link.

11. A device as recited in claim 1 wherein said apparatus for calculating a risk is in communication with said means for signalling via a physical connection selected from the group consisting of wire and fiber optic connections.

12. An overhead obstacle detector for mounting on an use with an over the road motor vehicle in order to detect overhead obstacles that the vehicle may encounter and warn the driver of the vehicle prior to contact between the vehicle and the overhead obstacles, the overhead obstacle detector comprising:
a signal emitter capable of emitting a signal that can ping overhead objects in the path of the vehicle that the overhead obstacle detector is serving,
a receiver for receiving signals reflected from overhead objects,
a distance calculator for calculating the distance between the vehicle and an overhead object,
a risk calculator for calculating a risk of collision the vehicle and an overhead obstacle that has been pinged, and
means for warning the vehicle driver when risk of collision with an overhead obstacle is high.

13. A device as recited in claim 12 wherein said signal emitter emits an ultrasonic signal.

14. A device as recited in claim 12 wherein said risk calculator utilizes vehicle speed and distance between vehicle and an overhead obstacle in assessing risk of collision.

15. A device as recited in claim 12 wherein said risk calculator utilizes a risk parameter modeled as a virtual spring in assessing risk of collision.

16. A device as recited in claim 12 wherein the overhead obstacle detector further comprises a housing, and said housing is mountable to the upper portion of a vehicle.

17. A device as recited in claim 12 wherein the overhead obstacle detector is mounted within a motor vehicle.

18. A device as recited in claim 12 wherein the overhead obstacle detector is constructed as an integral part of a motor vehicle.

19. A device as recited in claim 12 wherein said risk calculator is in communication with said means for warning by use of an device selected from the group of wire, fiber optics, wireless radio frequency signal and infra-red optical signal.

20. An overhead obstacle detector for mounting on an use with an over the road motor vehicle in order to detect overhead obstacles that the vehicle may encounter and warn the driver of the vehicle prior to contact between the vehicle and the overhead obstacles, the overhead obstacle detector comprising:
a signal emitter capable of emitting a signal that can ping overhead objects in the path of the vehicle that the overhead obstacle detector is serving,
a receiver for receiving signals reflected from overhead objects, and
a risk calculator for calculating a risk of collision the vehicle and an overhead obstacle that has been pinged.
